(19) United States
(12) Patent Application Publication
(10) Pub. No.: US 2002/0067274 A1
(43) Pub. Date: Jun. 6, 2002

(54) WIND TURBINE HAILSTORM PROTECTION SYSTEM HAVING A HAILSTORM SENSOR TO SIGNAL FOR CHANGING TURBINE BLADE POSITIONS

(76) Inventor: Mark E. Haller, Riverfalls, WI (US)

Correspondence Address: Thomas S. Hahn, FULBRIGHT & JAWORSKI L.L.P., 801 Pennsylvania Avenue, N.W., Washington, DC, 20004, US

(21) Appl. No.: 09/729,249

(22) Filed: Dec. 5, 2000

(51) Int. Cl. F03D 9/00; G01W 1/00

(52) U.S. Cl. 340/601

(57) ABSTRACT

An apparatus and method are provided for detecting and tracking hailstorms to generate warning signals to installed wind turbines, and to control wind turbine blade positioning and rotation to minimize blade surface areas presented to possible hail impacts. The hailstorm detecting and tracking sensor used for the present invention can be located either at a remote location from a wind turbine installation or at the wind turbine location. Multiple wind turbines at single or multiple locations can be protected using the present invention. Minimization of wind turbine blade presented surface areas to hail impacts can be achieved by turning blade edges into the wind, stopping rotation of rotors to which blades are attached, or by turning the rotor rotation axis ninety degrees to on-coming wind. Any one or a combination of these blade reorientations or functionings can be implemented using the present invention.

### BACKGROUND OF THE INVENTION

1. Field of the Invention

The present invention relates in general to protecting wind turbines from damage caused by hail, and, more particularly, to use of remote weather sensing devices, such as radars, for detecting and tracking hailstorms as they approach installed wind turbines and then using the information derived from the remote weather sensing and tracking devices to direct stoppage of the wind turbine and direct repositioning of wind turbine blades, including feathering of the blades, or yawing of the wind turbine so the blades are positioned to be least exposed to being struck by hail.

2. Discussion of the Prior Art

For decades the power of naturally occurring wind has been utilized by wind turbines to rotate mechanical structures ranging in complexity from grain grinding wheels to electrical generator rotors that produce electrical power. Beginning several decades ago the technologies for designing, building, operating and maintaining wind turbines that produce electrical power had progressed to the point where such wind turbine machines could be operated to produce both sufficient quantities and quality of electrical power that the produced electrical power could be feed into commercial power grids that supply both residential and industrial customers. These facts, along with certain favorable financial considerations, resulted in actual installation and operation of wind turbines to feed electrical power into commercial power grids. By the late 1970s not only had single or even small associated clusters of wind turbines (e.g., three-to-five or so) been installed and operated at multiple separate sites, but large associated arrays of wind turbines (e.g., upward of hundreds) had been installed and operated at multiple separate sites. Businesses have now been established to build wind turbine machines, develop land sites for their installation, operation and maintenance, and terms such as “wind farms” or “wind parks” came into use by those in the businesses to name the large associated arrays of installed wind turbines.

Preferably, of course, sites where wind turbines are to be installed are substantially selected on the basis that at such sites so-called windy conditions prevail. In more technical terms, higher wind speeds on average occur at such sites than occur at other neighboring sites, which are not those that should be selected for operation of wind turbines because less electrical power will be produced. A concomitant tradeoff that results from installing wind turbines at many of the predominately windy sites is that when storms occur the most severe weather conditions more often than not occur at the predominately windy sites.

Up to certain wind speeds wind turbines, depending on their design, can function effectively to convert the available wind power to electrical power. Above an effective maximum wind speed, wind turbines, depending on their design, can be operated at less efficient configurations, e.g., by adjusting the pitch of the blades capturing wind of some wind turbines, to produce electrical power, but because of the compensating blade pitch angles less electrical power is produced than theoretically is feasible from the available wind. Then above absolute maximum wind speeds, the pitch of the blades of some wind turbines has to be adjusted with respect to wind velocities so that the blades are effectively feathered, i.e., the aerodynamic shape of the blades is oriented with respect to wind velocities so that the wind will not apply forces on the blade surfaces to rotate the blade rotor structures about their central mounting axes. This type of wind turbine is commonly referred to as variable pitch machine. Another common method of controlling aerodynamic conversion of wind energy by wind turbine blades is to induce aerodynamic stall by designing a fixed twist angle for the blade along its longitudinal planform, such that lift and thus the resultant thrust and power are regulated by induced stall as the wind velocity reaches a predetermined, absolute maximum. These types of wind turbines are commonly referred to as stall regulated machines. Both of these types of wind turbine aerodynamic control methods work in conjunction with the rotational speeds of the rotors, either constant or variable speed. In today's modern wind turbines these rotational speeds are dependent upon rotor diameter. Common to both aerodynamic control methods are aerodynamic design optimizations that result in rotor tip speeds that range from 100 miles per hour (“mph”) on the extreme low end (typically stall regulated designs) to 175 mph on the high end (typically pitch regulated variable speed designs). In that wind turbine blades both need to have large surface areas upon which wind can interact and also must concurrently be light in weight to be most effective in transferring wind power to rotate electrical generator rotors, their design and construction have to provide a balance between strength and weight such that there will be an absolute maximum wind speed above which the blades will structurally fail. Critical to establishing a balance between strength and weight for blades is the material selected to make blades. The traditional materials have been wood, wood composites, metal and fiberglass. Today blades for large electricity producing machines are often made of fiberglass which currently optimizes the strength versus weight balance. In spite of the favorable strength versus weight balance provided by fiberglass, there is a countervailing possibility that fiberglass blades can be damaged including even punctured by projectiles such as hail.

In addition to wind induced forces that act on blades, the blade rotor, i.e., the structure to which the blades are attached, is subjected to counter forces resulting from inducing rotation of electrical generator rotors, these counter forces act in opposition to the forces resulting from the wind pushing the blades. Accordingly, wind turbine blades can be modeled as being subjected to forces produced by wind that act against surfaces of the blades which are mounted at their roots to semi-compliant rotor structures, i.e., the rotors are not able to freely rotate and in fact are subjected to counteracting forces. All told, it is advantageous that the aerodynamic shapes of wind turbine blades be controlled in their positioning in the case of variable pitch wind turbines, or their lift shedding design shape in the case of stall regulated rotors, with respect to wind in order to prevent wind generated forces from causing structural damage to the blades as wind speed increases. Operational experience has demonstrated that current wind turbine designs have been effective in being able to position blades or their blade planform shape so as to be able to survive even the highest predictable wind speeds. In order to be able to avoid damage during the most extreme circumstances, blades, on pitch controlled machines, need to be feathered to have the blade edges facing into the wind so that the wind blows over the blades but does not generate forces to rotate the rotors to which blades are attached, and, in the case of stall regulated machines, the machines need to be capable of stopping and locking the rotor, for example, through use of aerodynamic, electrodynamic, or mechanical braking forces used individually or in combination with each other. Stall regulated wind turbine blades typically require heavier structures to withstand large loads as well as long term operating fatigue loads, in part, due to such blades having more unfeathered area exposed to the wind than pitch controlled blades.

The capability to feather or to incorporate stall inducing aerodynamic shapes for wind turbine blades to protect blades and other structures from excessive forces when wind speeds exceed predetermined thresholds are effective designs that are either utilized after determining horizontal wind speeds and comparing the determined wind speed to preset maximum wind speeds or taking wind speed into consideration in designing such machines. Storms that produce excessive wind speeds often include high speed horizontal wind velocity components. However, such wind velocity patterns, i.e., those including high speed horizontal winds, are not always associated with storms that produce precipitation. For example, of particular concern to operators of wind turbines are storms that include hail because such storms may not produce excessive horizontal wind speeds, or may develop and progress such that the portions of the storm during which hail is falling are not periods when high speed horizontal winds are blowing. Therefore, even wind turbines with installed protection mechanisms to feather blades or stall and stop blades when wind speeds exceed threshold maximums would continue to permit their blades to turn through volumes of air in which potentially damaging hail could be present. In that hail is lumps of ice and compacted snow, they can have sufficient mass and hardness that when accelerated by gravity or even mild winds they would impact blades with sufficient momentum to damage the blade structures or even puncture them. Hail that has about an 0.25 inch diameter will fall, without wind acceleration, at about 25 mph, whereas larger hail having diameters of about three inches will fall, again without wind acceleration, at about 70 or more mph. In the case of rotating blades, though, the blades are not struck by such hail at those speeds but instead at the combination of the speed of the hail and the speed of rotation of the blade which at the tip can be up to, for example, 175 mph. Winds can accelerate hail, and, therefore, closing speeds can be well in excess of 200 mph which even for 0.25 inch diameter hail would most probably cause damage or even puncture of blade structures. Wind turbine blades can be protected from hail damage by feathering the blade edges into the wind or by incorporating stall inducing blade shapes and mechanisms. However, effecting stoppage of blade rotation during hailstorms requires more than monitoring wind speeds because hailstorms, even severe hailstorms with heavy precipitation concentrations, can occur during periods of moderate wind speed conditions. The bottom line is that if blades are not protected during hailstorms and the blades are severely damaged, then the blades must be replaced which not only can cost about $100,000 per blade, but also costs the value of the electricity that could have been generated if the blades were not damaged, and the added costs of labor and cranage needed to replace the blades. The costs of repair from even moderate hail impact damage can reach $30,000 per unit on what are considered modest size machines. Other resulting costs can include increased insurance rates or the loss of insurability for such machinery after the possibility of damage causing hailstorms is established.

### SUMMARY OF THE INVENTION

Wind turbines that generate electricity are machines which normally must be used whenever sufficient wind power is present to produce electricity. This requirement for maintaining wind turbine operation on as continuous a basis as is practicable is especially present for those wind turbines used to generate electricity that is supplied to utility power grids. Clearly, if there is insufficient winds to power wind turbines then operations are shut down. Alternatively, if prevailing winds are so strong that operation of the wind turbines would result in their being damaged then operations again have to be shut down. The processes and mechanisms for effecting such shut downs have been practiced successfully for years.

A weather phenomenon that prior procedures have not always been able to provide protection from which can cause substantial and expensive damage to wind turbines is hail, particularly if the wind turbine is operating during a hail event. The present invention meets this need in that it is not exclusively dependent on wind speed measurements, and, therefore, effects stopping and reconfiguration of wind turbines to avoid hail impact damage even when hail is falling during low to moderate wind conditions. Another aspect of the present invention is that it utilizes processes and mechanisms currently installed on individual wind turbines to adjust blade pitch angles or to brake rotors, and also to adjust the azimuthal orientation of blades with respect to prevailing winds.

To practice the present invention a sensor is utilized which can detect and track hailstorms. The sensor, which can be a radar, is installed at a location from which hailstorms can be tracked to determine if they will pass over locations where wind turbines are installed and operating. When such hailstorms are identified, the present invention sends signals to each wind turbine included in a system utilizing the present invention. Upon receipt of such a signal an included wind turbine effects a commanded shut down which would include a pitch adjustment on variable pitch wind turbines to turn the blades so that prevailing winds will not generate forces against blade surfaces to cause the rotors to which blades are attached to turn. Such reorientation of blades minimizes the presented areas against which hail can strike. On stall regulated machines, the same shut down command is issued such that aerodynamic, electrodynamic, or mechanical braking is initiated resulting in the rotor being stopped, thus reducing critical impact velocities, as is similarly the case with pitch regulated rotors.

As another aspect of the present invention, when a hailstorm present signal is received at a wind turbine the mechanisms used to adjust the azimuthal angle of the blades to prevailing winds can be energized to turn the blades so that the axis about which the blade rotor turns is position ninety degrees to the prevailing winds. Such a configuration results in the blades having an even further reduced presented area to the prevailing winds than that resulting from, for example, feathering alone. Thus, the blades are configured to be most protected from hail caused damage.

Finally, the present invention also provides a signal to each included wind turbine when a hailstorm has passed by, and the wind turbines upon receipt of such a signal can be reconfigured to resume normal operations.

### BRIEF DESCRIPTION OF THE DRAWINGS

Corresponding components in the various figures of the appended drawings are either designated by the same reference numerals or, if different reference numerals are used, their relationship is identified in the text. The various objectives, advantages and novel features of the invention will become more readily apprehended from the following detailed description when taken in conjunction with the appended drawings, in which:

FIG. 1 is a perspective view of a wind turbine that is usable with the present invention which has mechanisms for positioning and controlling attached blades used to convert wind power to rotational mechanical power;

FIG. 2 is a partial plan view showing a blade rotor with an attached blade and three axes about which the blade can be rotated for pitch control machines;

FIG. 3 is a perspective view of a blade rotor with three attached blades with a pitch control axis for each blade being shown;

FIG. 4 is a schematic view for an apparatus embodiment of the present invention that shows a hailstorm detecting and tracking sensor with interconnected wind turbines to be controlled for protection from hail damage;

FIG. 5 is a block diagram for a process according to the invention that is usable to control a wind turbine for protection from hail damage;

FIG. 6 is a block diagram for a process according to the invention that is usable to generate a hail present signal or a turbine restart signal from signals provided by a hailstorm detecting and tracking sensor;

FIG. 7 is a plan top view of a wind turbine shown as being turned ninety degrees from a prevailing wind with the same plan top view of the wind turbine shown in phantom as being in an upwind configuration with the prevailing wind; and

FIG. 8 is a block diagram for a process according to the invention that is usable to control multiple wind turbines for protection from hail damage.

### DETAILED DESCRIPTION OF THE PREFERRED EMBODIMENTS

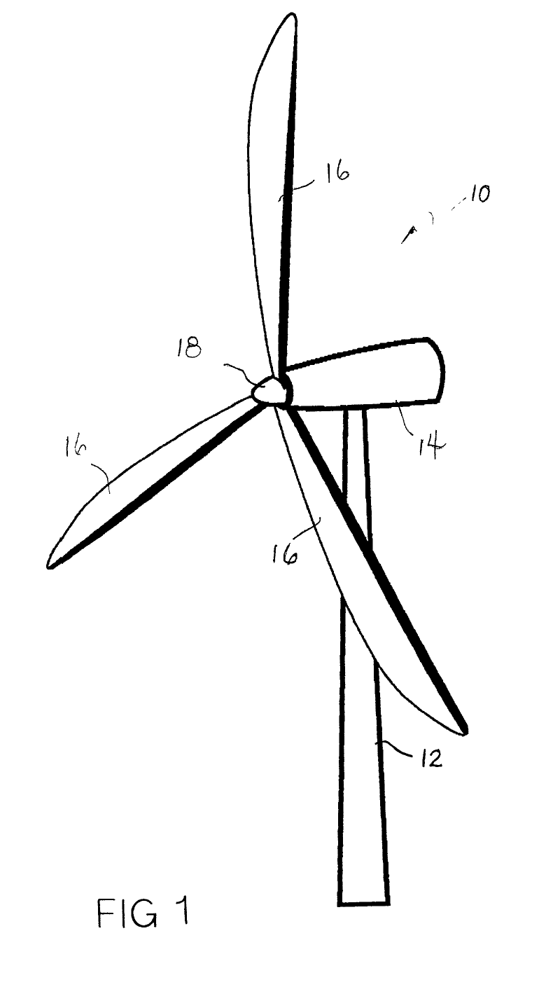

Shown in FIG. 1 is a perspective view for a generic wind turbine structure that can be used with the present invention. This generic wind turbine structure is designated by general reference numeral 10. Specially shown in FIG. 1 are a tower 12 that supports a nacelle 14 used to shelter equipment, e.g., gear boxes and electrical generators, and shown protruding from the nacelle 14 are blades 16 that are attached to a blade rotor structure 18 which structure extends into the nacelle 14. For the purpose of describing preferred embodiments for the present invention, the wind turbine 10 shown in perspective in FIG. 1, and also shown in greater detail in later figures herein is described as operating in upwind configurations. However, such wind turbine upwind operation is not a limitation of the present invention and wind turbines operating in downwind configurations are also within the scope of the present invention. Further, for the purpose of describing preferred embodiments for the present invention, the wind turbine 10 shown in perspective in FIG. 1, and also shown in greater detail in later figures herein is described as being a pitch control machine. Stall regulated machines are also within the scope of the present invention, and neither pitch control nor stall regulation are specific limitations of the present invention. Application of the present invention, upon study of this specification including the incorporated drawings by a person of ordinary skill in the art, to either upwind or downward wind turbine configurations, or to pitch control or stall regulated machines will be readily understood.

Two capabilities of the wind turbine 10 that are not necessarily apparent from the perspective view shown in FIG. 1 are that the nacelle and incorporated blade rotor 18 can be turned about the tower 12 to have the blade rotor 18 variably positioned in azimuth so as to have the wind advantageously directed either into the blades 16 from the front or back depending on whether the wind turbine is operated in either an upwind or downwind configuration. In addition to the capability of being able to turn the nacelle 14 about the tower 12 in azimuth, the wind turbine 10 also includes the capability to adjust the pitch, i.e., angular position, of the blades 16 with respect to the blade rotor 18.

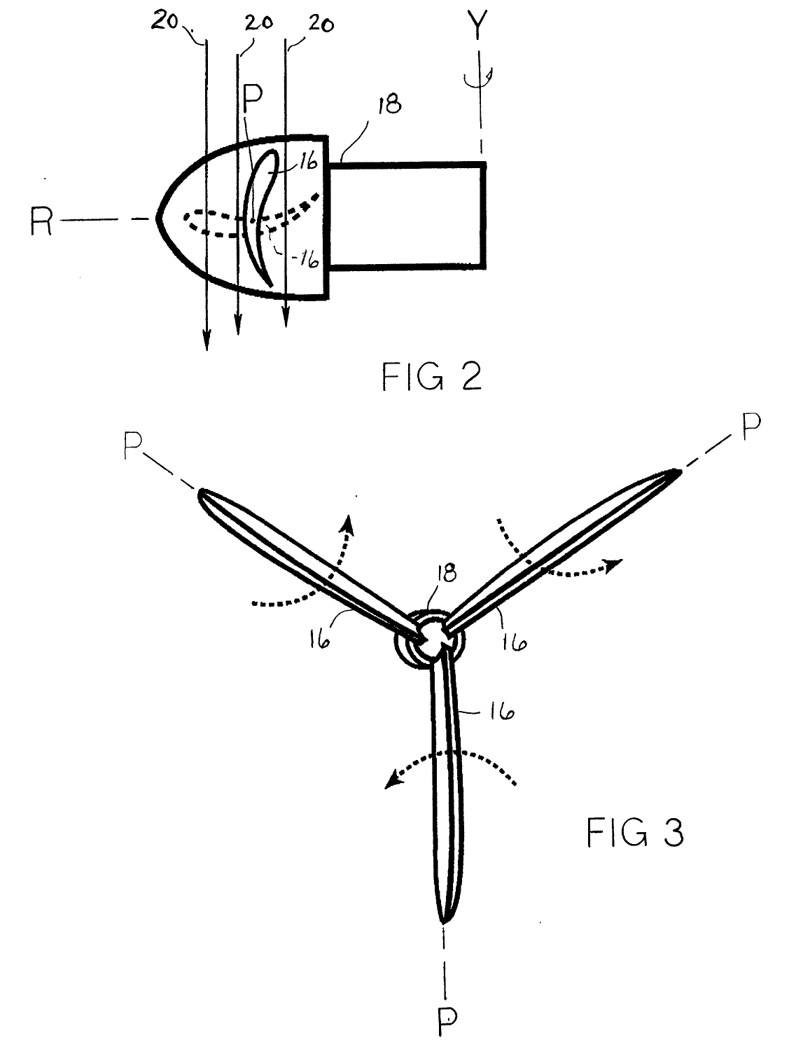

The axes for these various angular adjustments of blades 16 are shown in a partial plan view set out in FIG. 2. The direction of an exemplary prevailing wind pattern is represented in FIG. 2 by the arrow headed lines 20. Azmuthal orientation of the wind turbine 10 is shown in FIG. 2 as taking place about an yaw axis “Y”. While wind driven rotation of the blade rotor 18 is shown as occurring about a rotation axis “R”. The third angular orientation of the blades 16 is shown in FIG. 2 as being made about a pitch axis “P.” (See also FIG. 3). Adjustment of the pitch of the blades 16 to the prevailing wind is very important because it is the motion of air, i.e., wind, over the surfaces of the blades 16 that can generate forces to power rotation of the blade rotor 18, and, therefore, the blades 16 can be shaped to maximize generation of wind caused forces but achieving such results requires optimized orientation of blade 16 surfaces with respect to the wind. The trade-off against which maximizing wind generated forces acting against blade 16 surfaces at low to moderate wind speeds must be made is that at higher wind speeds blade 16 pitch angles must be adjusted to avoid optimized orientations for generating excessive forces acting against blade 16 surfaces. Otherwise blade 16 structural limitations could be exceeded as wind generated forces increase and the blades 16 could be irreversibly damaged.

In the case of very high wind speeds the pitch of blades 16 can be adjusted so that essentially no wind generated forces are produced to effect rotation of blade rotor 18 about axis “R”. Such an orientation of blades 16 with respect to the wind is known in the art as having blades 16 feathered.

A possible characteristic of hailstorms is that wind turbines 10, even those having blade pitch control mechanisms to provide protection from very high speed winds, could continue to operate, i.e., be configured to have wind act on blades 16, to produce rotation of blade rotor 18, because horizontal wind speeds are below maximum threshold values despite the presence of possible damage causing hail. The present invention satisfies the need to provide a way for wind turbines to be protected during hail storms irrespective of horizontal wind speeds.

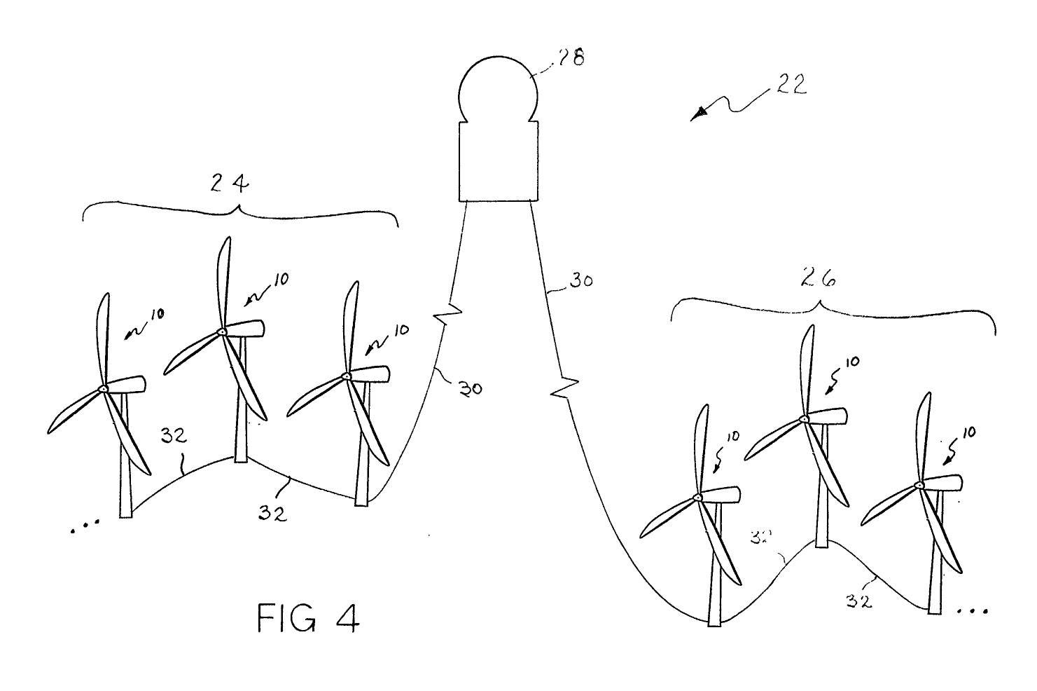

One preferred embodiment of the present invention is shown in schematic form in FIG. 4, where the embodiment for the present invention is designated by the general reference number 22. Shown in FIG. 4 are two separate wind turbine farms, which are generally designated by reference numerals 24 and 26. Though only three wind turbines 10 are shown in the wind turbine farms 24 and 26 depicted in FIG. 4, many more wind turbines 10, or even fewer, could be included in the wind farms 24 and 26. Further more than two wind farms could be included in the system 22, or even only one wind farm, or for that matter one wind turbine 10, could be included. Also shown as part of system 22 is a sensor 28. The sensor 28 which is discussed in greater detail below is used to detect and track storms that produce hail, and the sensor 28 is connected to the wind turbines 10 for transmission of electrical signals. The connection to the wind turbines 10 can be by hard wire, such as shown in FIG. 4 by wires 30 and 32, or by other ways such as radio systems, optical systems or combinations that provide communications between the sensor 28 and the individual wind turbines 10.

Since sensor 28 is used to detect and track storms that produce hail, it needs to be installed at a location from which the sensor 28 can detect and track storms that may pass over all or just a portion of the wind turbines 10 in the wind turbine farms 24 and 26. As shown in FIG. 4, the sensor 28 is installed at a location separate from either wind farms 24 and 26. Alternatively, the sensor 28 can be installed among wind turbines 10 of one of the covered wind turbine farms 24 and 26, or the sensor 28 can even be installed on top of one of the wind turbines 10. All of the above described alternative locations for installing sensor 28 are within embodiments for the present invention.

Sensor 28 as described above needs to be able to detect and track storms that produce hail, a fully adequate sensor to perform this function is a radar that operates in a frequency band between about 0.5 to 1.0 gigahertz (GHz) that is conventionally referred to as a “C” band radar. Radars operating in this band are capable of remotely detecting the presence of a storm and determining whether the storm is producing hail. Additionally, such a radar can track these storms. Though a C band radar has been specified as being a preferred device for sensor 28, other devices such as radars, operating in other bands, or optical devices such as LIDARs (a device that is similar in operation to radar but emits laser light instead of microwaves) can be used. For a device to be usable as a sensor 28 it must be capable of remotely detecting and tracking hailstorms.

Sensor 28 will be referred to herein as a radar, but as is discussed above the sensor 28 is not limited only to radars, mush less C band radars.

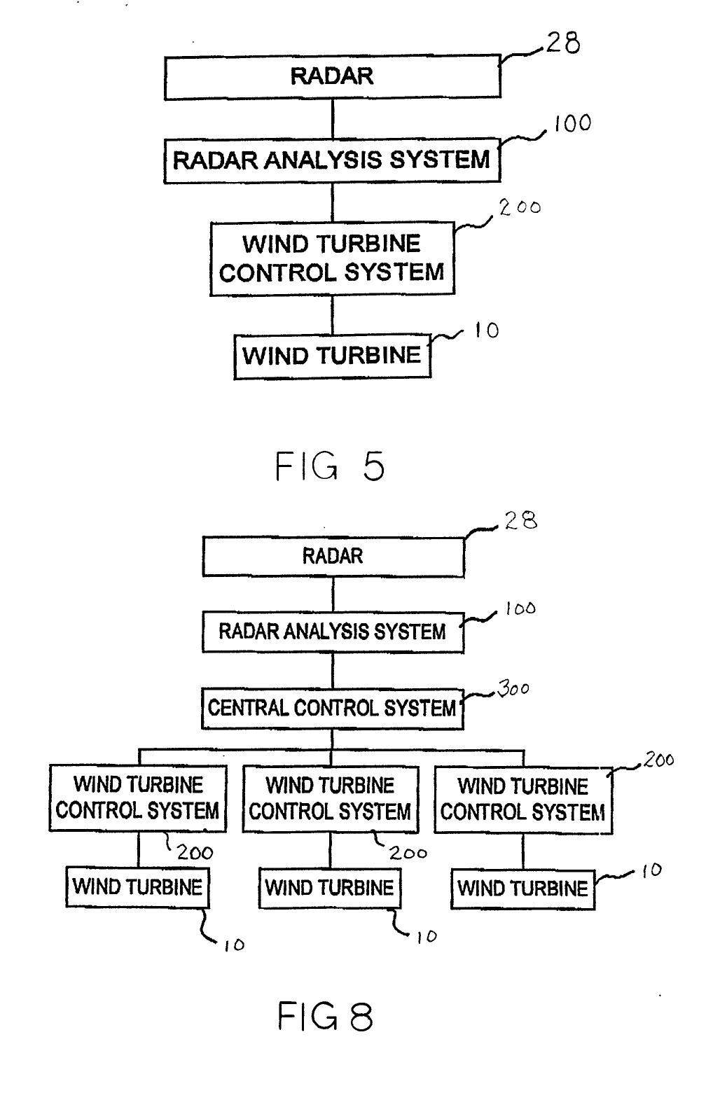

Turning to FIG. 5, a top-level block diagram for the method of the present invention is shown. Specifically, sensor 28 produced signals are processed in a radar analysis system step 100, which is described in detail below. The result of the processing at step 100 is a signal indicating that wind turbine 10: (i) can continue normal operation; (ii) should be configured for protection from hail damage; or (iii) is no longer threatened by hail damage. These signals are transmitted to a wind turbine control system step 200 to effect appropriate control of the configuration of wind turbine 10 with respect to prevailing wind patterns.

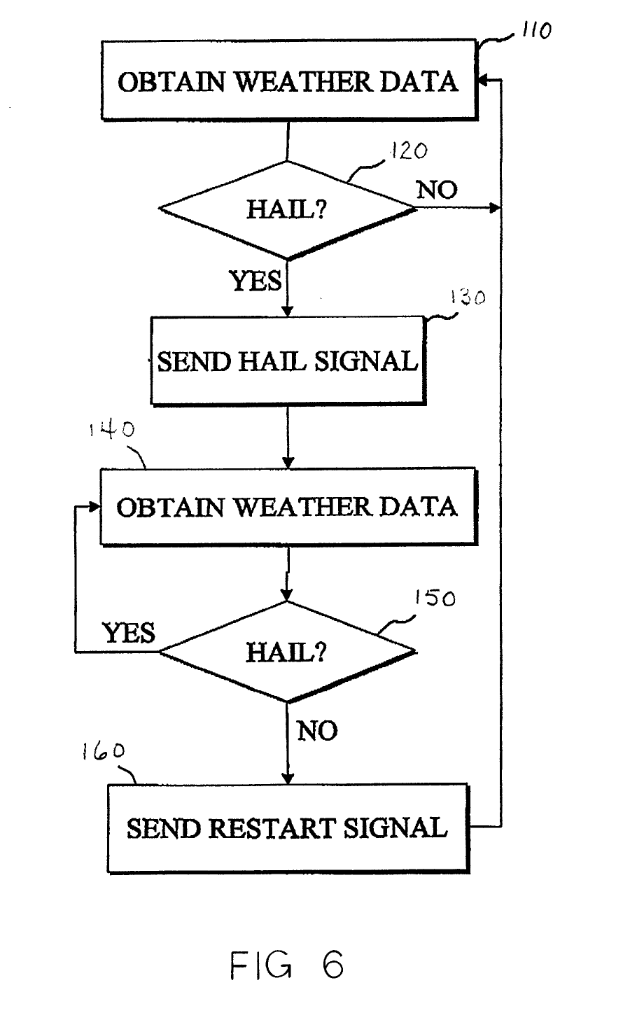

The process effected at the radar analysis system step 100 is shown in greater detail in FIG. 6. Initially the sensor 28 signals are processed at an obtain weather data step 110 to determine if any detected weather pattern is producing hail and is tracked as being headed to a wind turbine 10 such that hail could be striking the wind turbine 10 within a preset time period. The preset time period is determined as being a safe period during which the blades 16 of wind turbine 10 can be reoriented to protect them from hail. Using that determination, query 120, as to whether threatening hail is being produced, is answered. If the answer is no, the process returns to the obtain weather data step 110. Alternatively, if the answer is yes a hail present signal is sent to a wind turbine control system step 200 (see FIG. 5). Upon the sending of the hail present signal at a send hail signal step 130, the process proceeds to an obtain weather data step 140 to determine if the detected storm has ceased to produce hail or is tracked as no longer producing hail where the wind turbine 10 is installed. Using that determination, query 150, as to whether threatening hail is still falling at the installation location of wind turbine 10, is answered. If the answer is yes, the process returns to the obtain weather data step 140. Alternatively, if the answer is no a turbine restart signal (step 160) is sent to the wind turbine control system step 200.

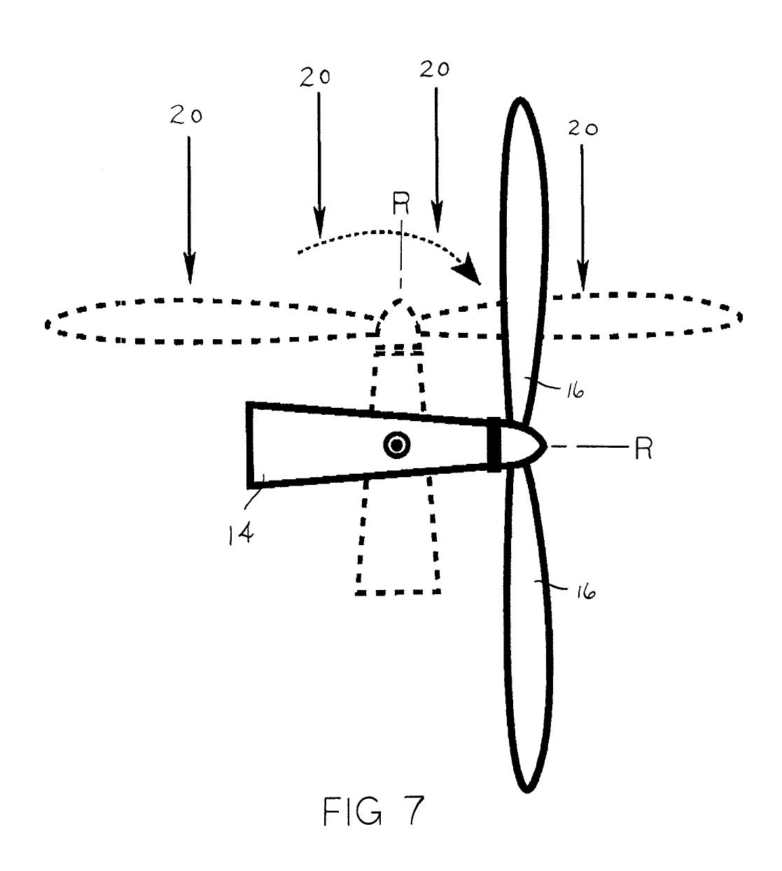

Returning to FIG. 5, the wind turbine control system step 200 can be provided with a hail present signal or a turbine restart signal depending on the presence or absence of hailstorms as is discussed above. If the wind turbine 10 is operating in a normal fashion and a hail present signal is received at the wind turbine control system step 200 the wind turbine 10 systems (not shown) used to change the azimuth of the blade rotor 18 and pitch of the blades 16 are energized. For one preferred embodiment, the so energized wind turbine 10 systems are used to change the pitch of the blades to a feather arrangement so that the prevailing winds are not presented with blade 16 surfaces that would result in the generation of forces that would cause the blade rotor 18 to turn. In the case of another preferred embodiment, the so energized wind turbine 10 systems are used to change the azimuth of the blade rotor 18 so that instead of having the rotation axis R being parallel to the direction of the prevailing wind 20, the rotation axis R is turned to be perpendicular to the direction of the prevailing wind 20 (see FIG. 7). This configuration for the blades 16 with respect to the wind 20 provides the smallest presented area for the blades to the wind 20. Therefore, this configuration will provide the highest protection to the blades 16 from hail damage.

Upon the receipt of a turbine restart signal at the wind turbine control system step 200 the wind turbine 10 systems used to change the azimuth of the blade rotor 18 and pitch of the blades 16 are energized to return the configuration of the wind turbine 10 to normal operation.

The above discussion is made in the context of only one wind turbine 10. Extension of the process of the present invention to control of multiple wind turbines 10 using one sensor 28 is shown in FIG. 8. As in FIG. 5, where control of one wind turbine 10 is shown, the sensor 28 sends signals to a radar analysis system step 100. At step 100 the same processes as are discussed above in conjunction with FIG. 6 are performed, except that multiple wind turbine 10 installation locations are used for processing the signals instead of one wind turbine 10 installation location. Accordingly, hail present and turbine restart signals are individually generated for each of the multiple wind turbine 10 installation locations. These signals are fed to a central control system step 300 where the hail present and turbine restart signals are sorted out for individual transmission to the appropriate wind turbine control system 200 and its associated wind turbine. Each of the wind turbine control system steps 200 function as discussed above. It is understandable from FIG. 8 and the above discussion that a large number of wind turbines 10 (e.g., more than three) can be connected to sensor 28 for being protected from hail damage.

The above discussion and related illustrations of the present invention are directed primarily to preferred embodiments and practices of the invention. However, it is believed that numerous changes and modifications in the actual implementation of the concepts described herein will be apparent to those skilled in the art, and it is contemplated that such changes and modifications may be made without departing from the scope of the invention as defined by the following claims.

What is claimed is:

1. A method for minimizing damage from hail to a wind turbine, comprising:
detecting presence of a hailstorm within the search area of a sensor;
tracking movement of the hailstorm using said sensor;
generating a warning signal upon determining that the hailstorm will pass over an
installation location for said wind turbine; and
adjusting the positions of one or more blades attached to said wind turbine to minimize presented surface areas of said blades from being struck by hail in response to generation of the warning signal.

2. The method of claim 1, comprising using a radar to detect and track a hailstorm.

3. The method of claim 1, comprising adjusting the positions of one or more blades so as to substantially halt rotation of a blade rotor to which the one or more blades are attached.

4. The method of claim 1, comprising adjusting the positions of said blades by changing azimuth position of a rotor axis for a rotor to which said blades are attached to be ninety degrees to the prevailing horizontal wind velocity.

5. A system for minimizing damage from hail to a wind turbine, comprising:
sensor means for detecting and tracking a hailstorm with respect to an installation
location for a wind turbine;
signal means for generating a warning signal if said sensor means determines a hailstorm will pass over said wind turbine installation location; and
stopping means for stopping rotation of a rotor to which one or more blades are attached, said stopping means being responsive to a warning signal sent by said sensor means that a hailstorm will pass over said wind turbine installation location.

6. The system of claim 5, wherein said sensor means is a radar.

7. The system of claim 5, wherein the one or more blades attached to said wind turbine are adjusted to substantially halt rotation of said rotor to which the one or more blades are attached.

8. The system of claim 5, wherein azimuth position of a rotor axis for said rotor is changed to minimize presented areas of said blades to being struck by hail.

9. A wind turbine system, comprising: a wind turbine having at least one blade attached to said wind turbine; a storm detector and tracking device operative to detect and track a hailstorm, said storm detecting and tracking device being capable of generating a warning signal when a hailstorm is predicted to pass over an installation location for said wind turbine; a blade control device operative in response to receipt of the warning signal to change the position of said blade to minimize presented area of said blade to being struck by hail.
